(19) United States
(12) Patent Application Publication
(10) Pub. No.: US 2006/0026248 A1
(43) Pub. Date: Feb. 2, 2006

(54) System and method for preparing electronic mails

(75) Inventors: Frederic Bauchot, Saint-Jeannet (FR); Francois-Xavier Drouet, La Gaude (FR); Gerard Marmigere, Drap (FR)

Correspondence Address: SCHMEISER, OLSEN + WATTS, 3 LEAR JET LANE, SUITE 201, LATHAM, NY, 12110, US

(73) Assignee: International Business Machines Corporation, Armonk, NY (US)

(21) Appl. No.: 11/189,592

(22) Filed: Jul. 26, 2005

(30) Foreign Application Priority Data
Jul. 29, 2004 (EP) 04291949.8

(51) Int. Cl. G06F 15/16

(52) U.S. Cl. 709/206

(57) ABSTRACT

A method and system for processing electronic mail. Electronic mails are created via specifications in a document that includes a recipient type section and at least two recipient content sections. The recipient type section identifies recipient types and recipient(s) of electronic mails for each recipient type. Each recipient content section identifies one or more recipients of the electronic mails and content to be selectively included in the electronic mail of only the one or more recipients. Creating electronic mails includes generating an electronic mail for each recipient. The electronic mail generated for each recipient contains a recipient list that includes the recipient as having the recipient type identified in the recipient type section. The electronic mail generated for each recipient contains the content of recipient content sections that identifies the recipient and does not contain the content of any recipient content section that does not identify the recipient.

### BACKGROUND OF THE INVENTION

1. Technical Field

The present invention generally relates to the field of computer-based electronic mail distribution and, more particularly, the invention relates to a method and system for creating electronic mail that includes selected portions of an initial message text and is addressed to different lists of recipients.

2. Related Art

The first electronic mail system used only some file transfer protocols, wherein in the message sent as a file, the first line contained the recipient's address. More elaborate electronic mail systems have been defined by RFC (Request For Comments) documents standardizing the mail transmission protocol such as the Simple Mail Transfer Protocol (SMTP), RFC 2821 and Internet Message Format RFC 2822. On the basis of this SMTP model, a user preparing a simple mail composes the text of the message and provides additional information which will be sent in a header of the message. The mail author indicates the sender address (‘From:’ field in the mail header), the recipient address which may be the address of final recipient (‘To:’ field), the address of the people in copy (‘Cc:’ field), and the address of people in ‘Blind Carbon Copy’ (‘Bcc:’ field). The “Bcc:” field contains addresses of recipients of the message whose addresses are not to be revealed to other recipients of the message. There are three cases in which the “Bcc:” field is used. In the first case, when a message containing a “Bcc:” field is prepared to be sent, the “Bcc:” line is removed even though all of the recipients (including those specified in the “Bcc:” field) are sent a copy of the message. In the second case, recipients specified in the “To:” and “Cc:” lines are each sent a copy of the message with the “Bcc:” line removed as above, but the recipients on the “Bcc:” line receive a separate copy of the message containing a “Bcc:” line. When there are multiple recipient addresses in the “Bcc:” field, some implementations actually send a separate copy of the message to each recipient with a “Bcc:” containing only the address of that particular recipient. In the third case, since a “Bcc:” field may contain no addresses, a “Bcc:” field can be sent without any addresses indicating to the recipients that blind copies were sent to someone. SMTP, by introducing these different recipient fields takes into account the need for preparing one mail for performing two operations: sending the mail to the primary recipients (‘To:’ field), officially informing other recipients on this sending (the ‘Cc:’ field) and independently informing other recipients on the previous sending. SMTP will generate all the mails corresponding to the three recipient lists. This avoids repetition of sending operations.

SMTP proposes a function for simplifying the management of the addresses, mainly based on the concept of directories and distribution lists. Directories which are either general shared directories or local address books, contain distribution lists which facilitate the sending to multi-recipients. According to SMTP, a mailbox is a virtual entity which corresponds or not to file storage and which receives mail for a recipient. When it is desirable to treat several mailboxes as a single unit (i.e., in a distribution list), the group construct can be used. The group construct allows the sender to indicate a named group of recipients without actually providing the individual mailbox address for each of those recipients. When the sender creates the message, the sender could put the name of the distribution list. Then, automatically, the mail application operating on its workstation creates a message for each member found in the list at the envelope level. The header of the message contains the name of the list which is expanded into the corresponding number of messages by SMTP.

In the same idea of optimizing the mail preparation, message senders may have to compose mails directed to several recipients belonging to different organizations, and where some pieces of information found in the message must not be shared with all the recipients. A typical situation falling in this case is a mail sent by an individual belonging to a first business organization A, and directed to a first set of recipients belonging to the same business organization A, and also directed to a second set of recipients belonging to another business organization B (e.g., a partner). In such a case, some confidential information may appear in the message, and the sender wants to restrict this information to the recipients belonging to his/her own business organization A. With the conventional mail systems available today, this requirement generates a tedious, error prone, manual process where the mail originator must:
first send to the recipients belonging to his/her own organization the full message (including the confidential information)
then manually build a second message derived from the first one by excluding the confidential information (copy/paste steps may be used here to avoid retyping the full second message)
and finally issue to the recipients belonging to the partner organization the second message where the confidential information has been flushed out.
   This process is clearly not user friendly, mostly in the cases where several different pieces of the message must receive several different audiences, according to rules specifying if a given subset of the message body is either restricted to a subset of the recipients, or excluded to a subset of the recipients.

Thus, there is a need not satisfied by the current mail systems today, to facilitate the operation of mail preparation when a series of mails is to be sent on the basis of the same message text.

### SUMMARY OF THE INVENTION

The present invention provides a method for processing electronic mail, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

The present invention provides a system for processing electronic mail, said system comprising a user agent of a client mail application, said user agent comprising a Simple Mail Transfer Protocol (SMTP) stack and a Selective Message Parser (SMP) for implementing a method for processing electronic mail, said SMP adapted to provide electronic mails resulting from said implementing to the SMPT, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

The present invention provides a computer program product comprising programming code instructions for executing, on a computer, a method for processing electronic mail, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

The present invention facilitates the operation of mail preparation when a series of mails is to be sent on the basis of the same message text.

### BRIEF DESCRIPTION OF THE DRAWINGS

FIG. 1 illustrates a SMTP model and an associated computing environment, in accordance with the present invention.

FIG. 2 depicts details of logical programming blocks forming a client mail application, in accordance with the present invention.

FIG. 3 illustrates preparation of four electronic mails in only one operation of electronic mail composing and sending, in accordance with the present invention.

FIG. 4 is a flowchart of a method for preparing different electronic mails when only one electronic mail preparation operation is performed, in accordance with the present invention.

FIG. 5 depicts details of the content and interactions of logical programming blocks forming the client mail application, in accordance with the present invention.

### DETAILED DESCRIPTION OF THE INVENTION

The present invention discloses a method executed on the client side of a mail management application for preparing electronic mails to be sent from the client side to the server side mail application, starting from an initial mail comprising a message text document and an initial list of recipient addresses displayed by a graphical user interface. A mail author enters through the graphical user interface of the client side of the mail management application and modifies in the initial mail the content of the message text document by introducing section tags on specific text sections, said section tags defining a list of recipient addresses extracted from the initial recipient list and specific to each said section. The section tags are identified and interpreted in such a way that different new mails are generated corresponding to the different message texts and recipient lists. The new mails are provided to the client side of the mail management application to be subsequently sent as standard electronic mails. In a second embodiment of the present invention, a modification of the list of recipients to which the new mails will be sent allows Reply mails of the new mails to additionally copy all the recipients having received a super set of the new mail.

The present invention provides a system and method to facilitate the preparation of different electronic mails (“e-mails”) in which multiple message texts are derived from a same message text, and to have these different e-mails sent to different recipients.

The present invention provides a method executed on the client side of a mail management application which sends electronic mails to the server side of the mail management application, said method for preparing electronic mails to be sent from the client, starting from an initial mail comprising a message text and an initial list of recipient addresses editable through a graphical user interface. The method comprises the steps of:
receiving from the graphical user interface of the client side of the mail management application section tags encompassing specific text sections, said section tags defining a list of recipient addresses extracted from the initial recipient list and specific to each said section;
identifying in the modified mail the section tags in the message text of the modified mail;
composing new message texts corresponding to the identified sections for each recipient of the initial recipient list;
grouping the recipients having the same new message text in at least one new recipient list and preparing at least one new mail for each at least one new recipient list, each new mail comprising a new message text and its corresponding new recipient list; and
giving the at least one new mail to be sent by the client side of the mail management application to the new recipient list inside the at least one new mails.

The present invention may further comprise the steps of:
computing a modified new recipient list for each at least one prepared new mail by adding the recipients of the new mails wherein the new mail message text is a super set of the message text of the at least one prepared new mail; and
giving the at least one modified new mails to be sent by the client side of the mail management application to the new recipient lists.

The present invention provides a computer program product comprising programming code instructions for executing the preceding methods of the present invention when said program code instructions are executed on a computer.

The present invention provides a system comprising means adapted for carrying out the methods of the present invention.

The present invention provides an advantage of allowing in one operation of mail preparation and sending, a capability of sending many e-mails with different message texts. Furthermore, each of these many e-mails may have different recipient lists.

The implementation of present invention is simple, since only the client mail application which is called User agent for the Simple Mail Transfer Protocol (SMTP) protocol, is modified. This modification is transparent to the mail server application, the local Mail Transfer Agent (MTA) for SMTP in charge of transferring e-mail messages over the network, and the recipient mail client application which does not need to implement the present invention.

Furthermore, with the present invention, the SMTP stack defined by the SMTP protocol, which is in charge in the user agent of sending the mails prepared to the MTA by reading the recipient list in the prepared mail, is not modified by the invention.

A Selective Mail Parser (SMP) new programming block implementing the invention in the user agent follows RFC2822 in term of type of recipients (To:, Cc: and Bcc:). Also, the delivery notification or Reply-to field which are not part of SMTP but implemented in the user interface of the usual user interface to the client mail management applications are also supported. In the archiving of mail, the sent folder may be also updated by the SMP implementing the present invention with a copy of the modified initial mail comprising the new tags of the invention and a copy of each of the new mails generated by the SMP.

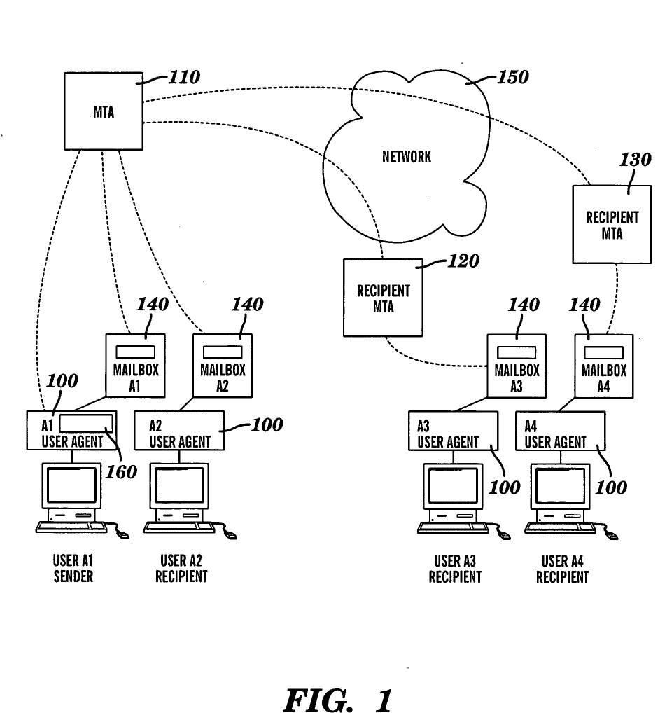

FIG. 1 illustrates a SMTP model and an associated computing environment, in accordance with the present invention. The SMTP model of the prior art is defined in RFC 2821 for distributing electronic mails. At the sender, the user agents 100 operating in the user workstations act as clients for their respective mail servers (110,120,130), called Mail Transfer Agents (MTAs). The user agents A1 and A2 are connected to the same MTA 110. At the recipients, the user agents A3 and A4 are connected to their respective MTAs (120, 130). The MTAs are in charge of managing recipient mail addresses for transferring and receiving mails either to and from the local user agents (A1, A2) or over the Internet network 150 to and from the remote MTAs (120, 130). The remote MTAs transfer and receive mails either to and from the local user agents (A3 and A4). The user agent sends a mail to its local MTA, said mail comprising the data itself and the recipient names. To deliver a mail to a local user agent, the MTA looks for the corresponding addresses of the recipients and puts the mail in a mail repository (i.e., mailbox 140 of the user agent which is the recipient for this mail). The sender and recipient names correspond to their respective mailbox identifiers.

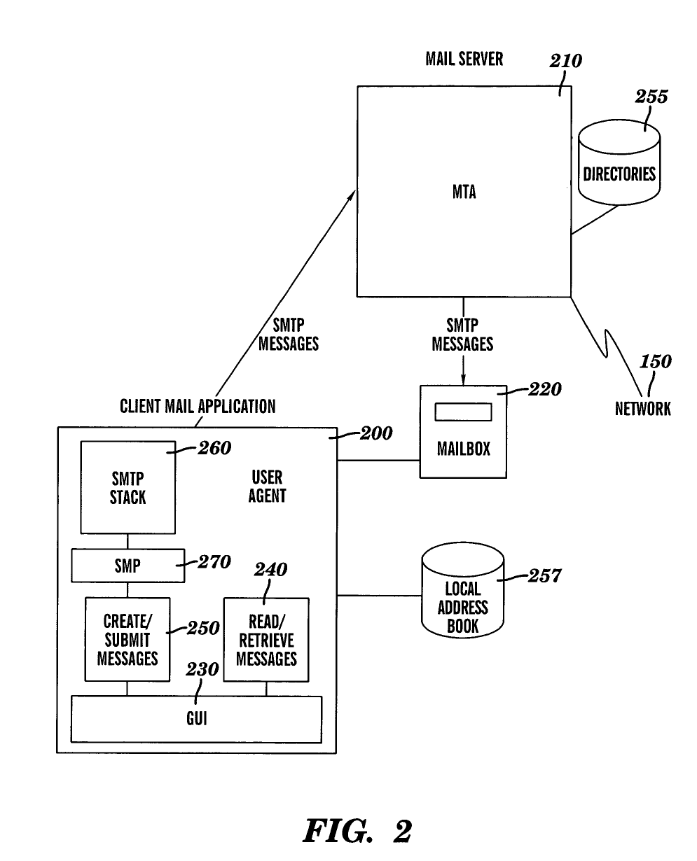

According to the present invention, by having an additional SMT programming block 270 (see FIG. 2) added to his mail client application 100 implementing SMTP, User A1, starting from a unique message text, can create different message texts for e-mail's to be sent to different recipient lists including user A2, user A3, and/or user A4.

FIG. 2 depicts details of logical programming blocks forming a client mail application, in accordance with the present invention. To send and receive e-mails, the Client Mail application 200 comprises a User Agent which includes a Graphical User Interface (GUI) 230 and comprises the following main functions:
Create message (by the Mail composer 250) which allows access to directories 255 stored by the local or remote MTA or directories from the local address book 257 which is the local space of the user;
Submit message 250, including the translation of the message compliant with “Internet Message Format” RFC2822, with the coding of the body part in Multipurpose Internet Mail Extensions (MIME) format. Document series RFC2045, RFC2046 and RFC2049 are relevant for this function;
The SMTP Stack 260 receives the message in the right format to be submitted via SMTP to the MTA;
Read/retrieve Messages 240 with access to the storage of the messages (mailbox 220). The messages are stored as described in RFC2822, so the GUI 230 has to parse the message to display the message to the user.

The User Agent also includes a Selective Message Parser (SMP) 270. The SMP allows the mail author through the GUI, to create different message texts selected from one message text, and to associate each message text to a recipient list. The SMP generates the corresponding e-mails that the SMTP stack 260 will send to the local MTA 210.

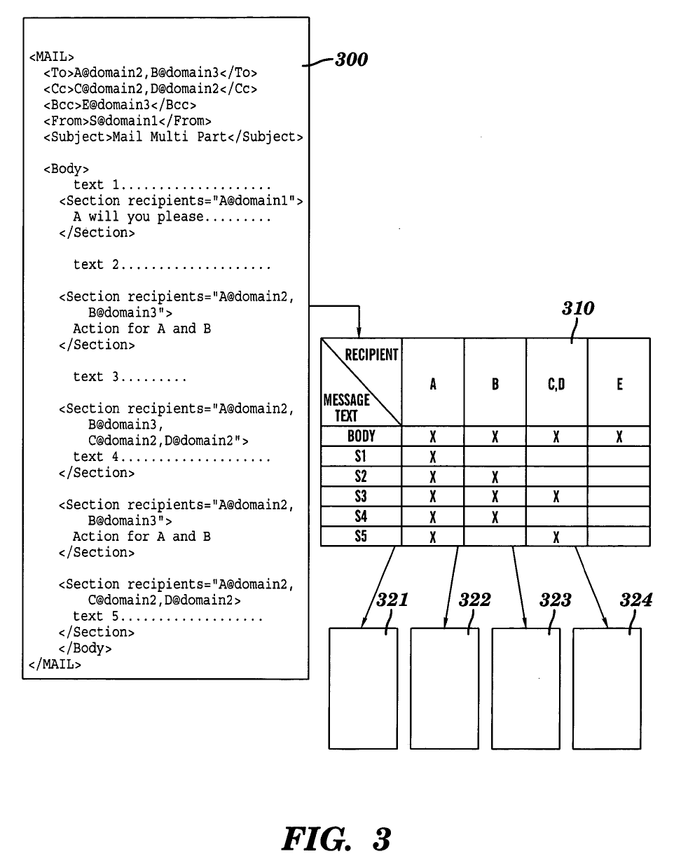

FIG. 3 illustrates preparation of four electronic mails 321-324 from a document 300 in only one operation of electronic mail composing and sending, in accordance with the present invention. One mail is composed and sent by the mail author at S@domain1, from which multiple mails 321-324 are subsequently submitted to SMTP. Initially, the method of the present invention prepares an initial mail with an initial distribution list and an initial message text. Then, the mail author, using the GUI editor of the ‘Create/Submit messages’ 250 of the user agent, enters a message text having new syntax elements. New tags are used such as XML tags: (<MAIL>, </MAIL> for defining the start and end of mail; <Body>, </Body> to define the beginning and end of message text, called the “body” of the mail, etc. . . . ) In the body part, the XML tag, <Section> has an attribute “recipients” which lists one or more recipients. Recipient name may be a fully qualified name name@realm), a local distribution list (myproject) or a remote distribution list project1@realm).

Using this syntax, an example of the initial mail is as follows:

```
<MAIL>
      <To>A@domain2,B@domain3</To>
      <Cc>C@domain2,D@domain2</Cc>
      <Bcc>E@domain3</Bcc>
      <From>S@domain1</From>
      <Subject>Mail Multi Part</Subject>
      <Body>
      Text
      </Body>
</MAIL>
```

This initial mail comprises a recipient type section identifying at least one recipient type (To, Cc, Bcc) and at least one recipient of electronic mails for each recipient type (A@domain2, B@domain3, C@domain2, D@domain2, and E@domain3) abbreviated as (A, B, C, D, E), respectively. Thus, the recipient type section is:

<To>A@domain2,B@domain3</To>
<Cc>C@domain2,D@domain2</Cc>
<Bcc>E@domain3</Bcc>

The recipients (A, B, C, D, E) are each an individual recipient or a distribution list. Using the facilities of SMTP, some recipients (A, B) are primary recipients (‘To’), other recipients (C, D) are in copy (‘Cc’), and additional recipients (E) are in hidden copy (‘Bcc’). Next, the text is split into at least one recipient content section and at least one body text section. The recipient content section identifies one or more recipients of the electronic mails and content to be selectively included in the electronic mail of only said one or more recipients. The body text section comprising text to be included in the electronic mail of each recipient identified in the recipient type section. Thus, each recipient content section contains a list of recipients to whom the content of the recipient content section will be selectively sent. The list of recipients for the recipient content section is a subset of the recipients of the initial mail in the recipient type section. The new Section tags for the different recipient content sections are used to define different mails. In the following example, in the initial text, some Sections have been identified and prepared as to be sent to a specific recipient list, and the body text sections (text 1, text2, text3) are not tagged with the new Section tags and are sent to the entire initial recipient list identified in the recipient type section.

```
<MAIL>
      <To>A@domain2,B@domain3</To>
      <Cc>C@domain2,D@domain2</Cc>
      <Bcc>E@domain3</Bcc>
      <From>S@domain1</From>
      <Subject>Mail Multi Part</Subject>
      <Body>
      text 1.......
      ..............................
      <Section recipients=”A@domain1”>
      A will you please ......................................
      </Section>
      text 2......................
      <Section recipients=” A@domain2,B@domain3”>
      Action for A and B
      </Section>
      text 3..........
      ...................
      <Section recipients=A@domain2,B@domain3,
      C@domain2,D@domain2,”>
      text 4 ...........
      </Section>
      <Section recipients=” A@domain2,B@domain3”>
      Action for A and B
      </Section>
      <Section recipients=” A@domain2,C@domain2,D@domain2>
      text 5............
      </Section >
      </Body>
</MAIL>
```

FIG. 3 illustrates the splitting of this initial mail (i.e., document 300) into four mails 321-324 corresponding to the example of initial mail tagged as given in the example above. Once the mail author has entered the tags in the initial mail, the mail is split into four mails 321-324. The splitting and target recipient lists are illustrated in table 310. Five recipient lists (or individual recipients) are cited as A, B, C, D, E. By reading the Section tags introduced in the initial text, the table 310 depicts the correspondence between the Sections of the text and the different recipient lists. The Body tag encompasses the recipient content sections (each identified by the Section tag) and the body text sections (text 1, text2, text3). Five sections are defined in the Body, the sections being entered as free text between the tag for section beginning (<Section>) and the tag of end of section (</Section>). The text of each recipient content section will be sent to only the recipients indicated in the beginning of each recipient content section following the (<Section> tag.

It is noted that the recipient list of each Section does not directly specify the recipient type of the listed recipients. However, the recipient type of each listed recipient is indicated in the initial mail recipient list (i.e., in the recipient type section). In the example, A and B are primary (‘To:’) recipients, as C and D are copies recipients (‘Cc:’) and E is in hidden copy of the initial mail (‘Bcc:’). The SMP will create four mails because four different message texts are defined for the five recipients (a, B, C, D, E). Recipient A will be a primary receiver (‘To:’ field of the initial mail) of a mail with a message text comprising the common text of the initial mail (text 1, text 2 and text 3) and all the sections (S1, S2, S3, S4 and S5). Recipient B will be a primary receiver of a mail (‘To:’ field of the initial mail) with a message text comprising the common part of the text of the initial mail (text 1, text 2 and text 3) and three sections (S2, S3 and S4). Recipient C will be a copied receiver (‘Cc:’ field of the initial mail) of a mail with a message text comprising the common part of the text of the initial mail (text 1, text 2 and text 3) and two sections (S3 and S5). Recipient D will be a copied receiver (‘Cc:’ field of the initial mail) of a mail with a message text comprising the common part of the text of the initial mail (text 1, text 2 and text 3) and two sections (S3 and S5). Recipient E will be a hidden copied receiver (‘Bcc:’ field of the initial mail) of a mail with a message text comprising the common part of the text of the initial mail (text 1, text 2 and text 3). The table 310 identifes each mail content for the different four mail instances 321-324 which will be created. For example, the text 5 in Section S5 will be sent only to the A, C, D recipients. Table 310 shows that a mail read by recipient A comprises only the common text part of the initial mail (text 1, text2, text3) and all sections created (S1-S5). Table 310 also shows that another mail will be sent to the recipients C and D which will have as message text the part of the common part of the initial mail (text 1, text 2 and text 3) and the sections S3 and S5.

The four resulting mails 321-324, which are created by the Selective Mail Parser, are each regular SMTP mails. These four mails with be provided to the SMTP stack for usual sending to MTAs.

Following the same example, the contents of the four mails 321-324 are as follows, the lines starting with ‘!!>>>>>>>>’ being comment lines:

```
For A: (mail 321)
<MAIL>
      <To>A@domain2 </To>
      <Cc></Cc>
      <From>S@domain1</From>
      <Subject>Mail Multi Part</Subject>
      <Body>
      text 1.......
      ..............................
!! >>>>>>>> This part is view only by A
      A will you please .......................
!! >>>>>>>> end of part viewed only by A
      text 2......................
!! >>>>>>>> This part is view only by A and B
      Action for A and B
!! >>>>>>>> end of part viewed only by A and B
      text 3..........
      text 4 ...........
!! >>>>>>>> This part is viewed only by To:
            Action for A and B
!! >>>>>>>> end of parts viewed only by To:
!!>>>>>>> This part is viewed only by A,B,C and D
      text 5...........
!!>>>> end of part viewed only by A,B,C and D
      </Body>
</MAIL>
```

It is noted that the excluded part for the ‘Bcc:’ recipient are not mentioned as far as the ‘Bcc:’ recipient by definition does not appear in the mail for the ‘To:’ and ‘Cc:’ recipients.

```
For B: (mail 322)
<MAIL>
      <To>B@domain3</To>
      <Cc></Cc>
      <From>S@domain1</From>
      <Subject>Mail Multi Part</Subject>
      <Body>
      text 1.......
      ..............................
      text 2......................
!! >>>>>>>> This part is viewed only by A and B
      Action for A and B
!! >>>>>>>> end of part viewed only by A and B
      text 3..........
      text 4 ...........
!! >>>>>>>> This part is viewed only by A and B
            Action for A and B
!! >>>>>>>> This part is viewed only by A and B
      </Body>
</MAIL>
For C and D (mail 323)
<MAIL>
      <To> </To>
      <Cc> C@domain2,D@domain2</Cc>
      <From>S@domain1</From>
      <Subject>Mail Multi Part</Subject>
      <Body>
      text 1.......
      ..............................
      text 2......................
      text 3..........
      text 4 ...........
!!>>>>>>>> This part is view only by A,C and D
      text 5...........
!!>>>>>>> end of part viewed only by A,C and D
      </Body>
</MAIL>
For E (mail 324)
<MAIL>
      <To> </To>
      <Cc></Cc>
      <Bcc> E@domain3</Bcc>
      <From>S@domain1</From>
      <Subject>Mail Multi Part</Subject>
      <Body>
      text 1.......
      ..............................
      text 2......................
      text 3..........
      </Body>
</MAIL>
```

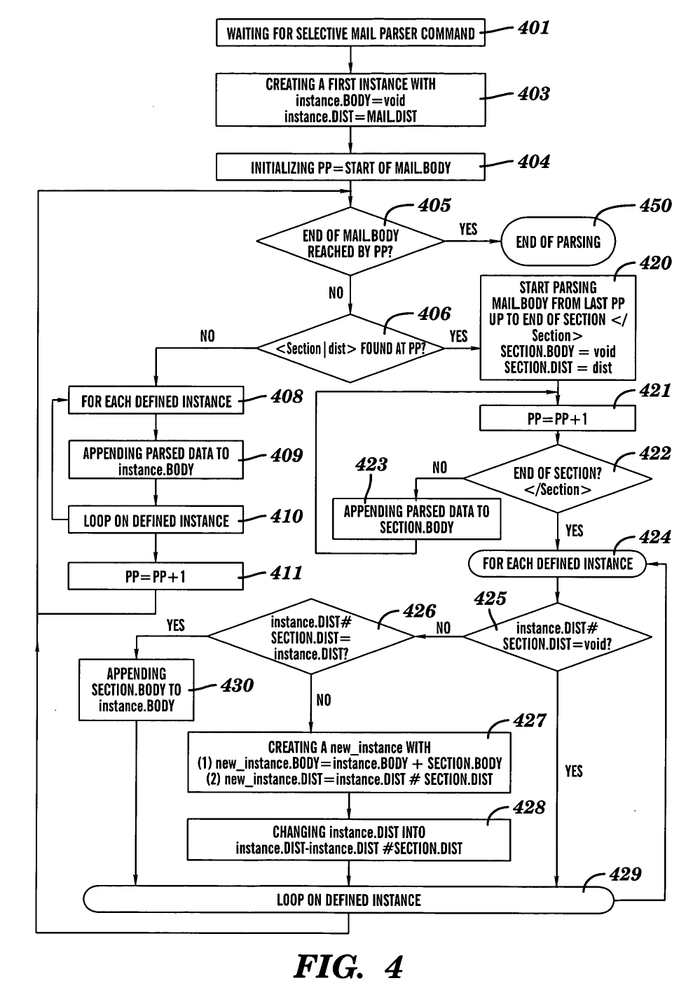

FIG. 4 is a flowchart of a method for preparing different electronic mails when only one electronic mail preparation operation is performed, in accordance with the present invention. The mail author (at S@domain1) has prepared the new mail and asked for the ‘send’ command to be executed, for example by pushing a button in a screen of the GUI. The SMP intercepts this new mail and a parsing step is performed by the SMP which reads as input, the mail prepared by the mail author, including the new section tags inserted in the mail body. From output of this parsing step, the necessary number of standard SMTP mails will be prepared to be provided to the SMTP stack for being submitted to sender MTA.

The SMP is responsible via specific algorithms to parse the message to identify which part of the message body has to be selectively sent to the indicated recipients. The SMP re-creates from the previous messages several different messages with new Msg-IDs identifying the SMTP messages. The SMP follows RFC2822 in term of type of recipients To, Cc, Bcc. Thus, if there is Bcc, new instances of mails will be created while removing the Bcc for the To and Cc recipients and new messages will be created for each Bcc recipient. If the same content of the message is sent to several recipients, one message is created with only recipients (To, Cc) in the header.

Optionally, before sending the new mails, the SMP saves in the sent folder, which is the place where the e-mail sent by the user is archived, the initial mail document 300 modified by the introduction of the new section tags and the new mails 321-324 generated by the SMP.

If a client mail application uses the Msg-ID for the correlation of the delivery notification or Reply-to field (function for replying to a received mail), then the functionality is kept with the method of the present invention. The SMP mechanism is transparent to the SMTP mailing functions. As described in the flowchart of FIG. 4, the instances created by the SMP are sent according to the rules of respecting for each recipient list of the mail instances, the type of recipient as indicated in the list of recipients in the recipient type section of the initial mail. When a recipient of a mail uses the Reply function, a new mail will be automatically created with a recipient list with recipients from the ‘From:’, ‘To:’, ‘Cc’ recipient lists at the maximum. When a recipient of the new instance mails generated by the SMP will perform a Reply, the Reply mail will contain only recipients authorized to access the message text.

The flowchart of FIG. 4 describes the parsing operation performed on the modified initial mail document 300 which contains new Section tags. A result of this parsing is creation of the necessary number of instances of the MAIL object. According to the present invention, an assumption concerning the object definition is that MAIL has two attributes: BODY which represents the complete mail body enclosed in tags <BODY>, </BODY> and DIST which represents all the recipients enclosed in tags (<To>, </To>), (<Cc>, </Cc>), (<Bcc>, </Bcc>). The INSTANCE object has two attributes: BODY (containing the message text), and DIST (list of recipients). SECTION has two attributes: BODY and DIST (for distribution list). MAIL.BODY=base+N sections. The sections are not nested; they start with keyword <Section|dist>, and end with keyword </Section>.

When the Mail has been composed using the mail composer, the Selective Message Manager is called in step 401 prior to passing the mail instances to the SMTP client. The Selective Message Manager creates both a first void instance of mail (instance.DIST) and a distribution list (instance.DIST) associated to said previously created instance.BODY in step 403. This first instance.BODY is initialized with the list of recipients specified in the mail by tags <To>, <Cc> and <Bcc>. This list of recipients is named MAIL.DIST. Then a Parsing Pointer (PP) is initialized to point the first line of the complete mail body (MAIL.BODY) in step 404. At this point each line of the MAIIL.BODY will be parsed to detect section tags, or to detect the end of MAIL.BODY in step 405. If the PP points to the end of mail body then the parsing ends in step 450, and the process is resumed with all instances identified being passed to the SMTP client to be sent to the recipients on their respective distribution list.

If the PP does not point to the end of MAIL.BODY (answer NO to test step 405), then a test is performed in step 406 to verify if the parsed line corresponds to the beginning of a section identified by the tag <Section dist=d1,d2, . . . >. If it is NO to test step 406, then for each defined instance (step 408) the parsed line is appended to addressed instance in step 409 and if an other instance exists step 410 triggers looping back to step 408 to process the next instance. After all the instances are processed, the parsing pointer (PP) is incremented, in step 411, to point the next line of the BODY and a checking is done in step 405 against the end of MAIL.BODY tag (</Body>).

If the beginning of a section (i.e., recipient content section) has been detected (answer YES to test step 406), then the parsing of the section is started in step 420 by initializing the section body (SECTION.BODY) to void and initializing the section distribution list (SECTION.DIST) with the list of recipients specified as argument of the section tag. Note that SECTION.BODY as well as SECTION.DIST are working areas. At step 421, the parsing pointer (PP) is incremented to point the next line of the section and a checking is done in step 422 for the end of section tag (</Section>). If the end of section tag is not detected (answer NO to test step 422), the parsed line is appended to the SECTION.BODY in step 423 and the parsing of the section continues. Else, in the case of end of section found (answer YES to test step 422), the SECTION.BODY has been completely built and a scanning of all previously defined instances is performed to decide if the section body has to be appended to an existing instance or if a new instance has to be created (424). A first checking in step 425 verifies if the intersection (# used as symbol to represent intersection between two sets) of instance.DIST and SECTION.DIST is void. If the answer to test step 425 is YES, then no recipient associated to the section has been found in the instance recipients list, and if step 429 determines that another instance exists then the next instance is processed in step 424, if step 429 determines that another instance does not exist then the method loops back to step 405 to again test the end of MAIL.BODY tag.

If the intersection of instance.DIST and SECTION.DIST is not void (answer NO to test step 425), then some of the recipients are referenced both in the SECTION.DIST and instance.DIST, and said intersection is compared to the instance.DIST in step 426 to verify if the list of recipients specified in the section is strictly equal to the list of recipients belonging to the instance. If the answer to test step 426 is YES, then SECTION.BODY is appended to the instance.BODY in step 430 and step 429 is next executed. If the answer to test step 426 is NO, then a new instance (named new instance) is created in step 427 with new_instance.BODY initialized with instance.body to which the SECTION.BODY is appended and new_instance.DIST is initialized with the intersection of instance.DIST and SECTION.DIST (recipients common to instance and SECTION). Then, the new_instance.DIST recipients are removed from the instance.DIST in step 428 and step 429 is next executed.

When the MAIL instances are created by the SMP, the mails are provided to the standard SMTP stack. All recipients are extracted from the Mail instance (To:, Cc:, Bcc:) and one Mail instance body is sent to the recipients without the Bcc line. Other behaviors may be implemented according to prior art possible behaviors. In the other behaviors, independent message(s) with the Bcc line is (are) sent to the Bcc recipients. If several messages are sent to the Bcc recipients, then the Bcc line contains only the address of the recipients.

The SMP new programming block implements the invention in the user agent in accordance with the recipient fields (‘To:’, ‘Cc:’, ‘Bcc:’) of RFC2822, and supports also the delivery notification or Reply-to field which are not part of SMTP but are implemented in the user interface of the client mail management applications. However, in an embodiment of the invention, the Reply function can be modified to support in a more convenient way the recipients of the multiple mail generated with the method as explained supra. When a user receives a message, the user may reply to a message, which is a GUI functionality. There are several implementations. The GUI allows the user to reply to a message and provides functionality to copy automatically in the new mail: the mail author which was in the ‘From:’ field; the list of recipients which was in the ‘To:’ and the ‘Cc:’ fields of the received message; and the text of the received message. The GUI function does not have any impact on the SMTP protocol. When a user replies to a message, the user creates a new message. This created new message is provided to the SMTP stack according to the usual process in the user agent.

Returning to the Selective Mail Parser described supra in reference to FIG. 4, the multiple new mails which are generated from an initial mail document are sent by the SMTP protocol to the recipients. Each recipient may create a Reply mail wherein the system automatically generates a recipient list with the ‘From:’, ‘To:’ and ‘Cc:’ recipient lists of the received mail. Some recipients of the instance mails generated by the SMP will not be copied on the Reply of instance mails, even though the instance mail that they have themselves received contained already all the parts of the Reply mail as illustrated hereunder with the preceding example.

Reading the columns of the table 310 of FIG. 3, in the automatic recipient list of a Reply message performed by C, there will be only the mail author (in the ‘To:’ field) and D (‘in the ‘Cc:’ field) as recipient of the Reply. However, recipient A receiving a message text including the entire message text of C may be interested in receiving the Reply message of C. Determining the super set of message text allows finding an ideal recipient list of the Reply mails.

Following the example of the four instances of mails to be generated by the SMP, the recipient lists of the mail Reply to the mails generated by the SPM may be improved by adding other recipients as follows:
The mail instance sent to A@domain2 does not contain any other recipient in copy, since all other recipients receive a subset of the mail received by A@domain2.
The mail instance sent to B@domain3 should contain A@domain2 in copy because the A instance is a super set of the B instance, while C, D, E are each a subset of B. A@domain2 will be a ‘Cc:’ recipient of a Reply mail created by the B@domain3 recipient.
The mail instance sent to C@domain2 and D@domain2, should contain A@domain2 in copy because the A instance is a super set of the C and D instance, while B and E are not. A@domain2 will be a ‘Cc:’ recipient of a Reply mail created by the C@domain2 and D@domain2 recipients.

The mail instance sent to E@domain3 should contain all other recipients in copy because the E instance is a subset of all other instances. All the other recipients will be ‘Cc:’ recipients of a Reply mail created by the E@domain3 recipient.

For A, the following instance mail created by the SMP is not modified: SMTP Recipient: A

```
<MAIL>
      <To>A@domain2 </To>
      <Cc></Cc>
      <From>S@domain1</From>
      <Subject>Mail Multi Part</Subject>
      <Body>
      text 1.......
      ..............................
!! >>>>>>>> This part is view only by A
      A will you please .......................
!! >>>>>>>> end of part viewed only by A
      text 2......................
!! >>>>>>>> This part is view only by A and B
      Action for A and B
!! >>>>>>>> end of part viewed only by A and B
      text 3..........
      text 4 ...........
!! >>>>>>>> This part is viewed only by To:
            Action for A and B
!! >>>>>>>> end of parts viewed only by To:
!!>>>>>>> This part is viewed only by A,B,C and D
      text 5...........
!!>>>> end of part viewed only by A,B,C and D
      </Body>
</MAIL>
```

For B, the following instance mail prepared by the SPM is modified to add A@domain2 as recipient:

SMTP Recipient: B

```
<MAIL>
      <To>A@domain2,B@domain3</To>
      <Cc></Cc>
      <From>S@domain1</From>
      <Subject>Mail Multi Part</Subject>
      <Body>
      text 1.......
      ..............................
      text 2......................
!! >>>>>>>> This part is viewed only by A and B
      Action for A and B
!! >>>>>>>> end of part viewed only by A and B
      text 3..........
      text 4 ...........
!! >>>>>>>> This part is viewed only by A and B
            Action for A and B
!! >>>>>>>> This part is viewed only by A and B
      </Body>
</MAIL>
```

For C and D the following instance mail prepared by the SPM is modified to add A@domain2 as recipient:

SMTP Recipients: C,D

```
<MAIL>
      <To>A@domain2 </To>
      <Cc> C@domain2,D@domain2</Cc>
      <From>S@domain1</From>
      <Subject>Mail Multi Part</Subject>
      <Body>
      text 1.......
      ..............................
      text 2......................
      text 3..........
      text 4 ...........
!!>>>>>>>> This part is view only by A,C and D
      text 5...........
!!>>>>>>> end of part viewed only by A,C and D
      </Body>
</MAIL>
```

For E, the following instance mail prepared by the SPM is modified to add all the other recipients of the initial mail recipients:

SMTP Recipient: E

```
<MAIL>
      <To>A@domain2,B@domain3 </To>
      <Cc>C@domain2,D@domain2</Cc>
      <Bcc> E@domain3</Bcc>
      <From>S@domain1</From>
      <Subject>Mail Multi Part</Subject>
      <Body>
      text 1.......
      ..............................
      text 2......................
      text 3..........
      </Body>
</MAIL>
```

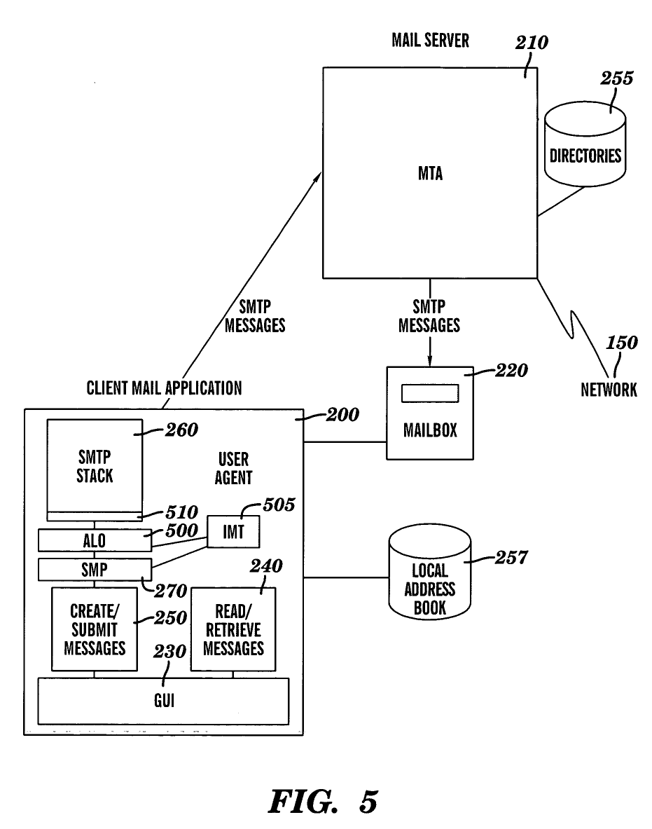

FIG. 5 depicts details of the content and interactions of logical programming blocks forming the client mail application, in accordance with the present invention. In a second embodiment of the present invention, the programming blocks and their interactions improve Reply mails which may be created by the recipients of the instance mails generated by the SMP. As described supra, the mail author using the GUI 230 of the message Create/Submit function 250 modifies the message text of an existing initial mail document 300 (see FIG. 3). The SMP 270 intercepts this document and generates multiple mail instances 321-324 as defined in the modified initial mail. The Selective Mail Parser 270 of the present invention, instead of sending the mail instances it has generated to the SMTP stack as described supra in conjunction with FIG. 2, alternatively sends the mail instances to the Address List Optimizer (ALO) 500 as well to an Instance Mail Table (IMT 505) that stores the information in the table 310 of FIG. 3. The ALO identifies the recipients to be added to the recipient list of each potential Reply of mail instance. These new recipients are those for which the message text of the mail instance is a super set of the message text of the corresponding instance mail of the Reply mail. The ALO, when adding new recipients, always maintains the same type of recipient as were already defined in the initial mail.

Then, the ALO sends to a new programming layer 510 of the SMTP stack 260 replacing the function of the SMTP stack for preparing the list of recipients to whom the mail will be sent. The new programming layer 510 of the SMTP stack 260 receives the instance mails sent by the ALO in which the recipient list has been modified according to the rule described supra. The ALO also sends, to the new interface 510 of the SMTP stack 260, the instance mail recipient lists as they were prepared by the SMP before their modification by the ALO. With the new programming layer 510, the SMTP stack, instead of sending the modified instance mails to the recipients in the recipient list read inside the instance mail, will send the modified instance mails to the recipients in the mail recipient lists as they were prepared by the SMP. Consequently, a given instance mail will be sent to the recipient list computed by the SMP, but will also include a recipient list comprising all the recipients determined by the ALO.

In the second embodiment, the SMTP stack in the user agent, which is in charge of sending the mails previously prepared through the GUI and the Create/Submit programming block, is modified by the new programming layer 510 which prepares for the SMTP stack the new recipient lists to which the mails will be sent. The normal process, as defined in the SMTP protocol as reading the recipient list inside the mail, is by-passed. Thus, implementation of the second embodiment requires a modification in the SMTP protocol which defines the SMTP stack.

What is claimed is:

1. A method for processing electronic mail, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

2. The method of claim 1, wherein the document comprises at least one body text section, wherein each body text section comprises text to be included in the electronic mail of each recipient identified in the recipient type section, and wherein the electronic mail generated for each recipient identified in the recipient type section comprises the text of each body text section.

3. The method of claim 2, wherein the text of the body text sections and the content of the recipient content sections appearing in each electronic mail are sequenced in the same order in said each electronic mail as in the document.

4. The method of claim 1, wherein only one electronic mail is generated for a plurality of recipients identified in the recipient type section who are all identified or all not identified in each recipient content section, and wherein the recipient list of the only one electronic mail comprises the plurality of recipients.

5. The method of claim 1, said method further comprising modifying the recipient list of a generated electronic mail for a given recipient to include at least one other recipient identified in each recipient content section that identifies the given recipient.

6. The method of claim 1, wherein said generating is performed by a Selective Message Parser (SMP), and wherein said method further comprises providing by the SMP the generated electronic mails to a Simple Mail Transfer Protocol (SMTP) stack of a user agent of a client mail application.

7. The method of claim 1, wherein the at least one recipient type is selected from the group consisting of a To type, a Cc type, a Bcc type, and combinations thereof.

8. The method of claim 1, said method further comprising prior to said creating: providing to a sender of the created electronic mails a Graphical User Interface (GUI) for creating the recipient content sections of the document.

9. A system for processing electronic mail, said system comprising a user agent of a client mail application, said user agent comprising a Simple Mail Transfer Protocol (SMTP) stack and a Selective Message Parser (SMP) for implementing a method for processing electronic mail, said SMP adapted to provide electronic mails resulting from said implementing to the SMPT, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

10. The system of claim 9, wherein the document comprises at least one body text section, wherein each body text section comprises text to be included in the electronic mail of each recipient identified in the recipient type section, and wherein the electronic mail generated for each recipient identified in the recipient type section comprises the text of each body text section.

11. The system of claim 10, wherein the text of the body text sections and the content of the recipient content sections appearing in each electronic mail are sequenced in the same order in said each electronic mail as in the document.

12. The system of claim 9, wherein only one electronic mail is generated for a plurality of recipients identified in the recipient type section who are all identified or all not identified in each recipient content section, and wherein the recipient list of the only one electronic mail comprises the plurality of recipients.

13. The system of claim 9, said method further comprising modifying the recipient list of a generated electronic mail for a given recipient to include at least one other recipient identified in each recipient content section that identifies the given recipient.

14. The system of claim 9, wherein said generating is performed by a Selective Message Parser (SMP), and wherein said method further comprises providing by the SMP the generated electronic mails to a Simple Mail Transfer Protocol (SMTP) stack of a user agent of a client mail application.

15. A computer program product comprising programming code instructions for executing, on a computer, a method for processing electronic mail, said method comprising:
creating electronic mails in accordance with specifications in a document that comprises a recipient type section and at least two recipient content sections;
said recipient type section identifying at least one recipient type and at least one recipient of electronic mails for each recipient type;
each recipient content section identifying one or more recipients of the electronic mails and content to be selectively included in the electronic mail of only said one or more recipients;
said creating electronic mails comprising generating an electronic mail for each recipient identified in the recipient type section;
said electronic mail generated for each recipient identified in the recipient type section comprising a recipient list that comprises said each recipient as having the recipient type identified in the recipient type section;
said electronic mail generated for each recipient identified in the recipient type section comprising the content of each recipient content section that identifies said each recipient and not comprising the content of any recipient content section that does not identify said each recipient.

16. The computer program product of claim 15, wherein the document comprises at least one body text section, wherein each body text section comprises text to be included in the electronic mail of each recipient identified in the recipient type section, and wherein the electronic mail generated for each recipient identified in the recipient type section comprises the text of each body text section.

17. The computer program product of claim 16, wherein the text of the body text sections and the content of the recipient content sections appearing in each electronic mail are sequenced in the same order in said each electronic mail as in the document.

18. The computer program product of claim 15, wherein only one electronic mail is generated for a plurality of recipients identified in the recipient type section who are all identified or all not identified in each recipient content section, and wherein the recipient list of the only one electronic mail comprises the plurality of recipients.

19. The computer program product of claim 15, said method further comprising modifying the recipient list of a generated electronic mail for a given recipient to include at least one other recipient identified in each recipient content section that identifies the given recipient.

20. The computer program product of claim 15, wherein said generating is performed by a Selective Message Parser (SMP), and wherein said method further comprises providing by the SMP the generated electronic mails to a Simple Mail Transfer Protocol (SMTP) stack of a user agent of a client mail application.
